(19) United States
(12) Patent Application Publication
(10) Pub. No.: US 2011/0139592 A1
(43) Pub. Date: Jun. 16, 2011

(54) POWER ADAPTER WITH SWITCH

(75) Inventors: PING-SHENG SU, Tu-Cheng (TW); DA-WEI XING, Kunshan (CN)

(73) Assignee: HON HAI PRECISION INDUSTRY CO., LTD., Tu-Cheng (TW)

(21) Appl. No.: 12/964,752

(22) Filed: Dec. 10, 2010

(30) Foreign Application Priority Data
Dec. 10, 2009 (CN) 200920316970.7

(51) Int. Cl. H01R 13/70

(52) U.S. Cl. 200/51.02

(57) ABSTRACT

A power adapter (100) in accordance with the present invention comprises a first connector (1) comprising a negative contact (130), a ground contact (131) and a positive contact (132), a second connector (2) comprises a ground terminal (242), a negative terminal (241) and a positive terminal (243), a switch (3) disposed between the first connector (1) and the second connector (2), cables (4) connecting with the first connector (1) and the second connector (2), the number of the cable (4) is five and the cables (4) comprise a first negative wire (40), a first fire wire (42), ground wire (41), a second negative wire (43) and a second fire wire (44), the first fire wire (42) connecting with the positive contact (132) and the switch (3), the ground wire (41) connecting with the ground contact (131) and the ground terminal (242), the second negative wire (43) connecting with the negative terminal (241) and the switch (3), the second fire wire (44) connecting with the positive terminal (243) and the switch (3), a housing (5) comprises a top cover (51) and a bottom cover (52) assembled to each other.

### FIELD OF THE INVENTION

The present invention generally relates to a power adapter, and more particularly to a power adapter with a switch thereof.

### DESCRIPTION OF RELATED ART

With the development of technology, and very fast progress in computer capabilities, the application of computer and peripheral products becomes more widely and generally. The periphery of the existing computer comprises a power adapter usually, the internal structure of the power adapter assembled firstly and then a insulative cover is molded over the aforementioned structures, and melted plastic material may shot into internal structure, and results in higher reject ration.

Correspondingly, it is desired to have a power adapter with improved structure to address the problem stated above.

### BRIEF SUMMARY OF THE INVENTION

Accordingly, an object of the present invention is to provide a power adapter with a switch thereof.

In order to achieve the above-mentioned object, A power adapter in accordance with the present invention comprises a first connector comprising a negative contact, a ground contact and a positive contact, a second connector comprises a ground terminal, a negative terminal and a positive terminal, a switch disposed between the first connector and the second connector, cables connecting with the first connector and the second connector, the number of the cable is five and the cables comprise a first negative wire, a first fire wire, ground wire, a second negative wire and a second fire wire, the first fire wire connecting with the positive contact and the switch, the ground wire connecting with the ground contact and the ground terminal, the second negative wire connecting with the negative terminal and the switch, the second fire wire connecting with the positive terminal and the switch, a housing comprises a top cover and a bottom cover assembled to each other.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded, perspective view of a power adapter in accordance with the present invention;

FIG. 2 is similar to FIG. 2, but viewed from another aspect;

FIG. 3 is a partially assembled, perspective view of the power adapter shown in FIG. 1;

FIG. 4 is a partially assembled, perspective view of the power adapter after removing the upper shell shown in FIG. 1; and

FIG. 5 is an assembled perspective view of the power adapter shown in FIG. 1.

### DETAILED DESCRIPTION OF THE INVENTION

Reference will now be made to the drawing figures to describe the present invention in detail.

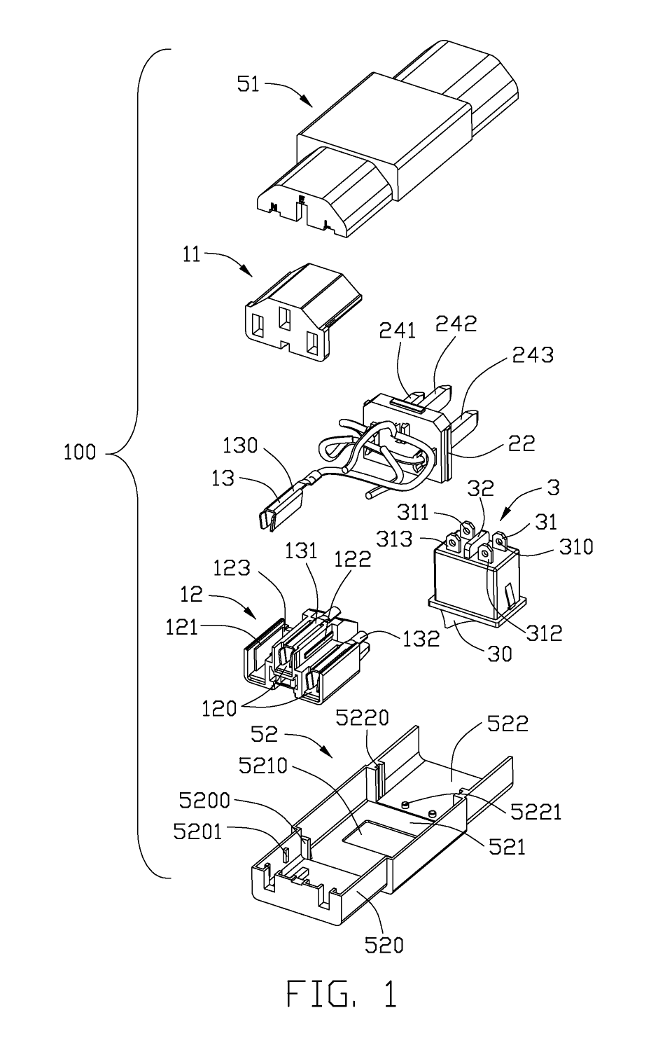

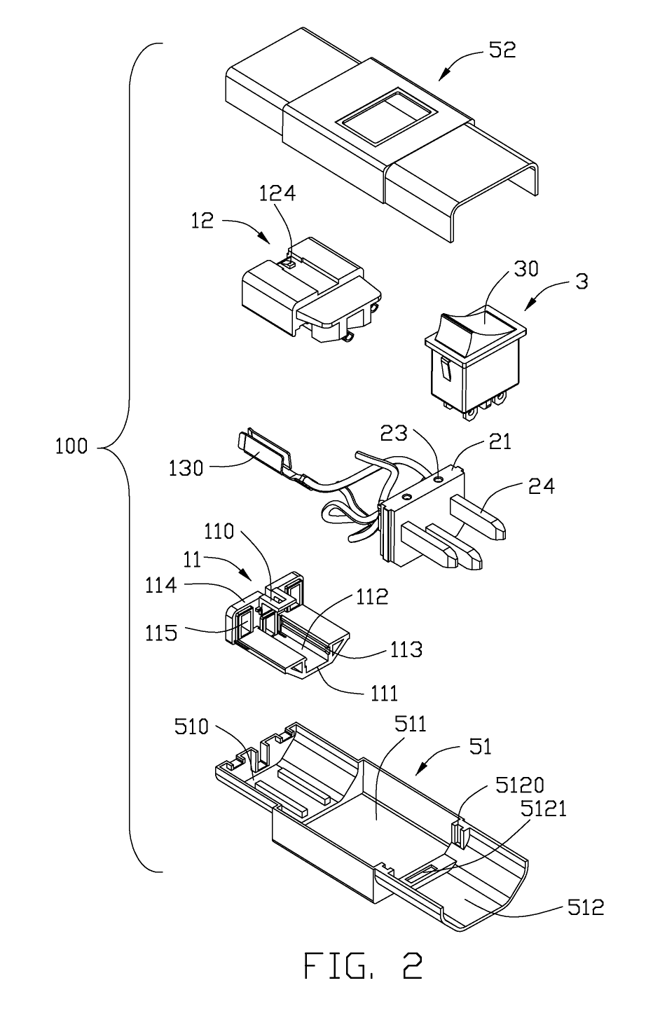

Referring to FIGS. 1-2, a power adapter 100 in accordance with the preferred embodiment of the present invention comprises a first connector 1, a second connector 2, a switch 3 connected with the first connector 1 and the second connector 2, and cables 4 connected with the first connector 1 and the second connector 2 and an insulative cover 5 molding over the first connector 1 and the second connector 2.

The first connector 1 main comprises a top plastic mold 11 and a bottom plastic mold 12 assembled to each other, three contacts 13 retained between the top plastic mold 11 and the bottom plastic mold 12. The three contacts comprises a negative contact 130, a ground contact 131 and a positive contact 132. A locking portion 110 extend forwardly from the back end of the lower surface of the top plastic mold 11. The plastic mold 11 defines a top wall 111, and a receiving groove 112 recessing upwardly from the lower surface of the top wall 111, the receiving groove 112 extending to the back surface of the top wall 111 along the front-to-back direction. The receiving groove 112 defines a pair of vertical wall with a notch 113 thereof to be communicates with the receiving groove 112. A front panel 114 connected with the top wall 111 and the front panel 114 defines three jacks 115, the middle of the jacks 115 connecting with the receiving groove 112.

The bottom plastic mold 12 defines three grooves 120 apart from each other, a pair of the slots 121 defined in the lateral sides of the grooves 120. The lateral walls of the middle groove 120 each defines a rib 122. The bottom plastic mold 12 includes a lower surface, and the rear of the lower surface defines a locking block 124 to be mated with the locking portion 110. The grooves 120 also comprise a stopper 123 to retain the grounding pin of the grounding line and the fire wire in the grooves 120. The top plastic mold 11 is assembled to the bottom plastic 12, and the locking block 124 of the bottom plastic 12 engages with the locking portion 110 to combine the top plastic mold 11 and the bottom plastic mold 12.

The second connector 2 comprises a rectangle-shaped frame portion 21 and a plurality of terminals 24 received in the frame portion 21. The terminals 24 comprise a negative terminal 241, a ground terminal 242 and a positive terminal 243. The upper surface and the lateral surface of the frame portion 21 each defines a stripe 22, and the bottom surface of the frame portion 21 defines a pair of position grooves 23.

The switch 3 is rectangular-shaped approximately, the area of the bottom surface of the switch 3 is larger than the upper surface thereof, and the bottom surface of the switch 3 defines a press-button 30, four solder pins 31 are arranged in the upper surface of the switch 3 and arranged in two rows along the front-to-back direction. The front row of the solder pins 31 defines a first solder pins 310 and a second solder pins 311, and the first solder pins 310 is located in the right side of the second solder pins 311. The back row of the solder pins 31 is defined a third solder pins 312 and a forth solder pins 313, and the third solder pins 312 is located in the right side of the forth solder pins 314. A platform 32 is located between the left row and the right row of the solder pins 31.

The number of the cable 4 is five, and three of the cables 4 are connected with the first connector 1, the three cables 5 comprises a first negative wire 40 connecting with the negative contact 130, a ground wire 41 connecting with the ground contact 131 and a first fire wire 42 connecting with the positive contact 132. The cables 4 also comprise three cables connecting with the second connector 2, the ground wire 41 connecting with the ground terminal 242 and the ground contact 131, a second negative wire 43 connecting with the negative terminal 241 and a second fire wire 44 connecting with the positive terminal 243.

The cover 5 comprises a top cover 51 and a bottom cover 52 assembled to each other. The top cover 51 defines a first top receiving portion 510 receiving the first connector 1, a second top receiving portion 511 receiving the switch 3 and a third top receiving portion 512 receiving the second connector 2. The bottom cover 52 comprises a first lower receiving portion 520 is mating with the first top receiving portion 510, a second lower receiving portion 521 is mating with the second top receiving portion 511, and a third lower receiving portion 522 is mating with the third top receiving portion 512. As the above mentioned, the first connector 1 is installed in a first receiving portion by the first top receiving portion 510 mating with the first lower receiving portion 520. The switch 3 is installed in a second receiving portion by the second top receiving portion 511 mating with the second lower receiving portion 521, The second connector 2 is installed in the third receiving portion by the third top receiving portion 512 mating with the third lower receiving portion 522. The rear of the third lower receiving portion 522 comprises a pair of lateral walls each defines a first groove 5220 receiving the lower section of the stripe 22 of the frame portion 21. the rear of the third lower receiving portion 522 also comprises a lower wall defines a pair of position pin 5221 mating with the position groove 23, the middle of the second lower receiving portion 521 defines an opening 5210 through the lower wall of the second lower receiving portion 521 to receive the press-button 30. The neighbor of the second lower receiving portion 521 and the first lower receiving portion 520 defines a block 5200 abuts against the stopper 123 to install part of the bottom plastic 12 behind the stopper 123 in the first lower receiving portion 520. A pair of protrude portion 5201 are located in the lateral walls of the first lower receiving portion 520. The rear of the bottom plastic mold 12 behind the stopper 123 is locked between the protrude portion 5210 and block 5200. The rear of the third top receiving portion 512 comprises a pair of lateral walls each defines a second groove 5120 receiving the upper section of the stripe 22 of the frame portion 21. A third groove 5121 defined in the rear of the upper wall of the third top receiving portion 512 receiving the stripe 22 upon the upper surface of the frame portion 21.

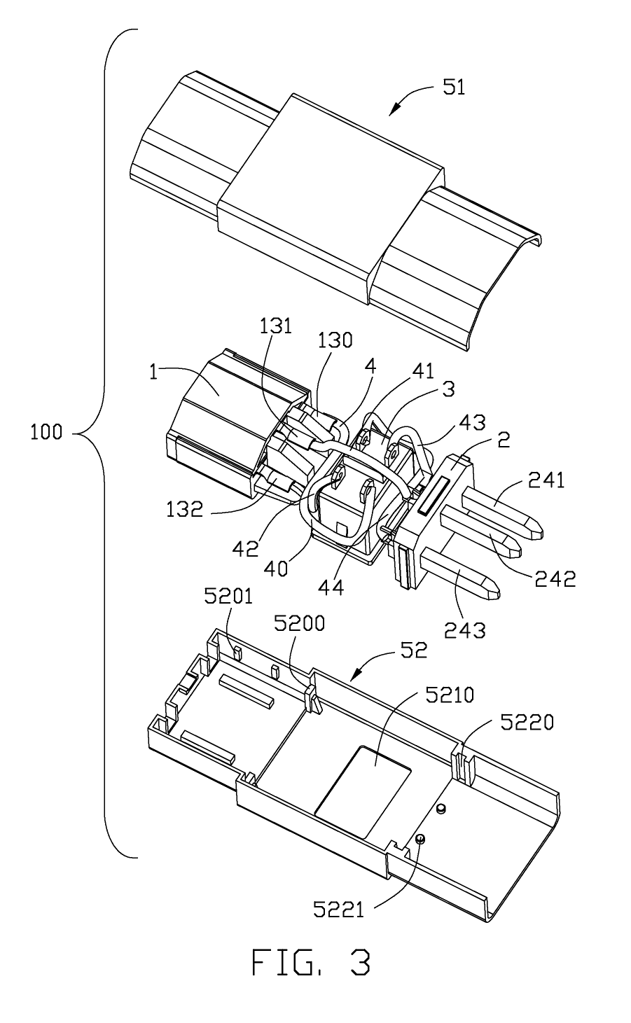

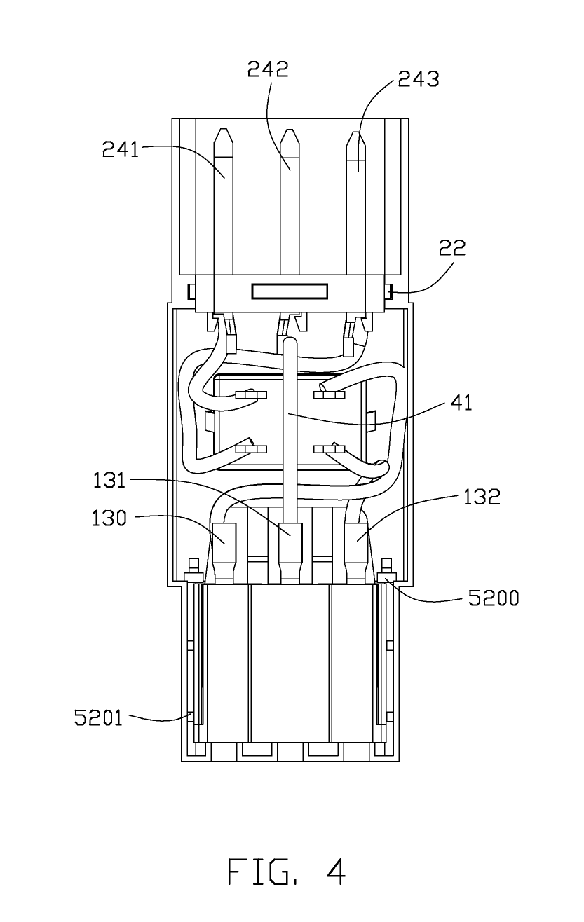

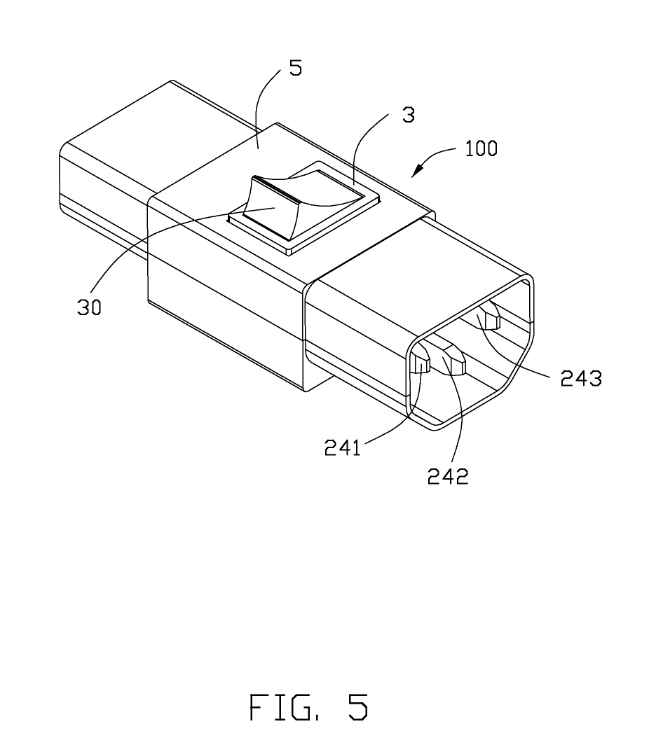

Referring to FIGS. 1-2 and 3-5, in assemble, firstly, put the negative contact 130, the ground contact 131 and the positive contact 132 in the groove 120 of the bottom plastic mold 12, and the protrude portion of the line pins are locked with the stopper 123 for installing the negative contact 130, the ground contact 131 and the positive contact 132 in the bottom plastic mold 12. then the top plastic mold 11 is assembled to the bottom plastic mold 12 via the ribs 122 locking in the notch 113. And at the same time, the ground terminal 242, the negative terminal 241 and the positive terminal 243 are installed in the frame portion 21, and the tail section of 241,242 forwardly extending beyond the front surface of the frame portion 21. Then, the switch 3 is disposed between the first connector 1 and the second connector 2. One end of the ground wire 41 connecting with the ground contact 131 of the first connector 1, and the other end of the ground wire 41 is connected with the ground terminal 242 of the second connector 2. And at the same time, the ground wire 41 is disposed on the platform 32. One end of the first ground wire 40 connecting with the negative contact 130, and the other end of the first ground wire 40 connecting with the first solder pins 310 of the switch 3. One end of the second negative wire 43 is connected with the negative terminal 241, and the other end of the second negative wire 43 connecting with the second solder pins 311. The negative current among the first connector 1, the switch 3 and the second connector 2 is formed via the first negative wire 40 connecting with the negative contact 130 and the switch 3, and the second negative wire 43 connecting with the negative terminal 241 and the switch 3. One end of the first fire wire 42 connecting with the positive contact 132, and the other end of the first fire wire 42 connecting with the switch 3, one end of the second fire wire 44 connecting with the positive terminal 243, and the other and of the second fire wire 44 connecting with the forth pins 313 of the switch 3. The positive current among the first connector 1, the switch 3 and the second connector 2 is formed via the first fire wire 42 connecting with the positive contact 132 and the switch 3, and the second fire wire 44 connecting with the positive terminal 243 and the switch 3.

Then the aforementioned elements are installed in the bottom cover 52 and the first connector 1 is disposed in the first lower receiving portion 520, the switch 3 is disposed in the second lower receiving portion 521 and the second connector 2 is disposed in the third lower receiving portion 522. The rear of the bottom plastic mold 12 behind the stopper 123 is locked between the protrude portion 5210 and block 5200 when the second connector 2 is assembled in the first lower receiving portion 520. the press-button 30 is disposed in the opening portion 5210 when the switch 3 is installed in the second lower receiving portion 521, and the lower surface of the switch 3 closing to the inner surface of the lower wall of the second lower receiving portion 521. The lower section of the stripe 22 of the frame portion 21 locking in the first groove 5220 at the second connector 2 is disposed in the third lower receiving portion 522. and the position pin 5221 is installed in the Position groove 23 of the frame portion 21. At the last step, the top cover 51 is combined to the button cover 52 via ultra-sonic welding process and the upper section of the stripe 22 is installed in the second groove 5120 of the frame portion 21, the stripe 22 which disposed upon the top surface of the frame portion 21 is installed in the third groove 5121.

A switch 3 is disposed between the first connector 1 and the second connector 2 to control the on/off status of first connector 1 and the second connector 2, and then the aforementioned elements are assembled in the lower cover 52, and the top cover 51 is assembled to the button cover 52 via ultra-sonic welding process to make the top cover 51 and the lower cover assembled together.

What is claimed is:

1. A power adapter, comprising:
a first connector comprising a negative contact, a ground contact and a positive contact;
a second connector comprises a ground terminal, a negative terminal and a positive terminal;
a switch disposed between the first connector and the second connector;
a plurality of cables connecting with the first connector and the second connector, the number of the cable is five and the cables comprise a first negative wire, a first fire wire, ground wire, a second negative wire and a second fire wire, the first fire wire connecting with the positive contact and the switch, the ground wire connecting with the ground contact and the ground terminal, the second negative wire connecting with the negative terminal and the switch, the second fire wire connecting with the positive terminal and the switch;
a housing comprises a top cover and a bottom cover assembled to each other to enclose the first connector, the second connector and the switch.

2. The power adapter as claimed in claim 1, wherein an upper surface of the switch defines four solder pins and arranged in the two rows along the front-to-back direction.

3. The power adapter as claimed in claim 2, wherein both of the front row and the back row comprises two solder pins.

4. The power adapter as claimed in claim 3, wherein the front row of the solder pins defines a first solder pin and a second solder pin, and the first solder pin is located in the right side of the second solder pin.

5. The power adapter as claimed in claim 4, wherein the back row of the solder pins defines a third solder pin and a forth solder pin, and the third solder pin is located in the right side of the forth solder pin.

6. The power adapter as claimed in claim 5, wherein the first negative wire connecting with the first solder pin, the first fire wire connecting with the third solder pin, the second negative wire connecting with the second solder pin, and the second fire wire connecting with the forth solder pin.

7. The power adapter as claimed in claim 5, wherein the bottom cover comprises a first lower receiving portion receiving the first connector, a lower second receiving portion receiving portion receiving the switch and a third lower receiving portion receiving the second connector.

8. The power adapter as claimed in claim 7, wherein the top cover comprises a first top receiving portion mating with the first lower receiving portion, a top second receiving portion mating with the second lower receiving portion and a third top receiving portion mating with the third lower receiving portion.

9. The power adapter as claimed in claim 8, wherein the top cover is assembled to the bottom cover via ultra-sonic welding process to make the top cover and the bottom cover together.

10. The power adapter as claimed in claim 9, wherein the second connector comprises a frame portion receiving the negative terminal, the ground terminal and the positive terminal, the upper surface and the lateral surface of the frame portion each defines a stripe, and the bottom surface of the frame portion defines a pair of position grooves.

11. The power adapter as claimed in claim 10, wherein the third receiving portion defines a first groove, a second groove and a third groove receiving the correspond stripe, and the bottom cover defines a position pin mating with the position groove.

12. A power adapter, comprising:
a first connector having a positive contact and a negative contact;
a second connector having a positive terminal and a negative terminal;
a switch electrically connected the first connector and the second connector; and
a cover having a top cover and a bottom cover together holding the first connector, the second connector and the switch therebetween.

13. The power adapter as claimed in claim 12, wherein the cables comprising a first negative wire connecting with the negative contact and the switch, a second negative wire connecting with the negative terminal.

14. The power adapter as claimed in claim 13, wherein the cables comprising a first fire wire connecting with the positive contact and the switch, a second fire wire connecting with the positive terminal.

15. A power adaptor comprising:
a case defining therein a receiving cavity between opposite first and second lengthwise ends in a lengthwise direction;
a first connector located at the first lengthwise end and including a plurality of first contacts;
a second connector located at the second lengthwise end and including a plurality of second contacts;
a switch located between the first connector and the second connector in said lengthwise direction, said switch including first set and second set of conductive pins; and
a plurality of wires connected between the conductive pins and the corresponding first contacts, and between the conducive pins and the corresponding second contacts, respectively; wherein
the switch defines a press button movable between a first position, where the first set and second set of conductive pins are electrically connected in the switch, and a second position, where the first set and second set of conductive pins are electrically disconnected from each other in the switch.

16. The power adaptor as claimed in clam 15, wherein the first contacts includes a first grounding contact and the second contact includes a second grounding contact electrically connected to said first grounding contact via an additional wire directly connected therebetween without involvement with the switch.

17. The power adaptor as claimed in claim 15, wherein the press button is moveable in a leveraged manner.

18. The power adaptor as claimed in claim 15, wherein said first connector is of a male type while the second connector is of a female type.
